(19) United States
(12) Patent Application Publication
(10) Pub. No.: US 2026/0280206 A1
(43) Pub. Date: Sep. 17, 2026

(54) ELECTRICAL MODULE FOR CONNECTING TO A MOUNTING RAIL, AND CONTACTING ELEMENT THEREFOR

(71) Applicant: Zumtobel Lighting GmbH, Dornbirn (AT)

(72) Inventor: Gerald Ladstätter, Klaus (AT)

(73) Assignee: Zumtobel Lighting GmbH, Dornbirn (AT)

(21) Appl. No.: 18/868,434

(22) PCT Filed: Jun. 13, 2023
(86) PCT No.: PCT/EP2023/065725

§ 371 Date: Nov. 22, 2024

(30) Foreign Application Priority Data
Jun. 21, 2022 (DE) 20 2022 103 438.9

(51) Int. Cl. H01R 25/14; F21V 21/35

(52) U.S. Cl. CPC H01R 25/142; F21V 21/35

(57) ABSTRACT

The invention relates to an electrical module (1) for connecting to a mounting rail, which has a mounting-rail profile (60) with two side walls and which also has at least one conductor rail, which is arranged on one of the two inner sides of the side walls of the mounting-rail profile and provides electrically contactable lines, wherein the electrical module (1) has a contacting element (10), which can be inserted into the mounting-rail profile (60) and has terminal contacts (24), which are provided so that, in a state in which the contacting element (10) has been inserted into the mounting-rail profile (60), they come into contact with lines of the conductor rail, wherein the contacting element (10) is mounted rotatably about an axis of rotation (I) with respect to a carrier element (30) of the electrical module (1) between an open position, in which insertion and removal of the contacting element (10) into and from the mounting-rail profile (60) are made possible, and a contacting position, in which the terminal contacts (24) contact lines of the conductor rail, wherein the contacting element (10) has a cable-guiding channel (50), which runs substantially along the axis of rotation (I) and is in line with a feedthrough opening (35) in the carrier element (30), and wherein at least one cable (55) is guided from one of the terminal contacts (24) through the cable-guiding channel (50) and the through-opening (35) onto the side of the carrier element (30) opposite from the contacting element (10), in order to supply power to an electronic component of the module (1).

### CROSS-REFERENCE TO RELATED APPLICATION

The present application is the U.S. national stage application of international application PCT/EP2023/065725 filed Jun. 13, 2023, which international application was published on Dec. 28, 2023 as International Publication WO 2023/247250 A1. The international application claims priority to German Patent Application No. 20 2022 103 438.9, filed Jun. 21, 2022.

### TECHNICAL FIELD OF THE INVENTION

The present invention relates to an electrical module according to the preamble of claim 1, which is to be coupled to a mounting rail, the mounting rail having a mounting-rail profile with two side walls and at least one conductor rail that is arranged in the mounting-rail profile and comprises contactable lines. The module according to the invention can be, for example, a luminaire, a camera or a sensor unit or generally a unit which is intended for use in a strip lighting system. Furthermore, the present invention relates to a corresponding contacting element for such an electrical module.

### BACKGROUND OF HE INVENTION

Mounting rails with a mounting-rail profile and a busbar held in the mounting-rail profile are known from the prior art, and are, for example, used for realizing elongate so-called strip lighting systems. A known strip lighting system is marketed by the applicant under the designation “TECTON,” and is characterized in that luminaires or other electrical consumers can be flexibly positioned on the mounting rail over the entire length of the system. This is made possible in that, due to a special mounting of the conductors of the busbar(s), they are accessible to consumers over essentially the entire length of the strip lighting system, such that a contacting of the conductors can take place not only at fixed, predetermined positions but rather at any point. For example, WO 2001/091250 A1 discloses such a strip lighting system.

In the “TECTON” system mentioned above, two conductor rails are arranged opposite one another on the inner sides of the two side walls of a U-shaped mounting-rail profile that is open at the bottom. The contacting of the conductors of these two busbars takes place by the luminaire, or generally speaking the consumer to be connected, having a rotatable contacting element that is inserted into the mounting rail from the underside and then rotated by approximately 45°. Contacts arranged on the contacting element are designed in this case in such a way that they pivot outward laterally upon rotation, and finally contact the conductors of the busbars after rotation. In addition to the electrical contacts, latching projections are also swiveled out to the side, which also serve to mechanically fasten the contacting element to the mounting rail. In the case of a luminaire, a carrier element is furthermore coupled to the contacting element, to which carrier element, for example, the lamps and any further electronic components for operating the lamps are attached.

In the mounting rail systems described above, these rotatable contacting elements, often also referred to as rotary taps, are generally arranged on both sides of the ends of the consumer to be connected to the mounting rail for stability reasons. This applies in particular to elongated luminaires, but also to shorter units, such as spots, sensors and the like. As a rule, only one of the two rotary taps is used for both mechanical fastening and electrically contacting the lines of the conductor rails; the second rotary tap at the opposite end is used only for stability reasons and ensures mechanical locking with the mounting rail.

However, this approach limits the possibilities for free arrangement thereof on the mounting rail, especially for shorter units, such as spots or sensors. The reason for this is that at the front end and at the opposite end of the mounting rail, the contactable lines of the conductor rails do not extend up to the furthest end, since measures must be taken here for feeding and for closing off the mounting rail or, optionally, for connecting it to another mounting rail. If two such rotary taps are used for a relatively short consumer to be connected, they are inevitably each located at the beginning and the end of the consumer, which in turn means that the consumer can only be arranged at a certain minimum distance from the beginning or the end of the mounting rail system.

A similar problem also arises when only a single rotary tap is used. In this case, this rotary tap is in turn located off-center and therefore more in the end region of the associated consumer, since the electrical components to be supplied with power are usually arranged in the center and, due to the cable routing required, the rotary tap must then be offset with respect to the electrical components. In addition, there is an uneven load distribution, which is also disadvantageous for fastening the consumer to the mounting rail.

### SUMMARY OF THE INVENTION

The object of the present invention is now that of offering an improvement here that makes it possible to further minimize the above-described limitations when positioning electrical modules on a mounting rail.

The object is achieved by an electrical module having the features of claim 1 and by a contacting element for an electrical module according to claim 10. Advantageous developments of the invention are the subject-matter of the dependent claims.

According to the present invention, it is provided to modify the contacting element in such a way that a channel for the passage of cables or wires is likewise available in the axis of rotation about which the contacting element can be rotated. In the case of an electrical module, it is then provided that, starting from one of the terminal contacts, at least one cable is routed through this channel and a correspondingly aligned through-opening in the carrier element of the electrical module to the side of the carrier element that is opposite the contacting element, in order to supply power to an electronic component of the module here. This opens up the possibility, for example in the case of relatively short electrical modules, of using only a single contacting element, which can now be placed in the middle, wherein the advantageous cable routing also allows the electronic component that is to be supplied with power, that is, for example, the spot or the sensor, to be positioned directly below the contacting element. This then not only leads to a central force flow that enables the use of a single contacting element, but also, due to the fact that the contacting element is no longer placed at the end region or edge region of the electrical module but is instead placed in the middle, leads to the advantage that the electrical module can now be arranged as far as the furthest edge of the mounting rail, despite any measures for feeding the conductor rails or for closing off the mounting rail system.

According to the present invention, an electrical module for connecting to a mounting rail is thus proposed, the mounting rail having a mounting-rail profile with two side walls and at least one conductor rail, which is arranged on one of the two inner sides of the side walls of the mounting-rail profile and provides electrically contactable lines,
wherein the electrical module has a contacting element, which can be inserted into the mounting-rail profile and has terminal contacts, which are provided so that, in a state in which the contacting element has been inserted into the mounting-rail profile, they come into contact with lines of the conductor rail,
wherein the contacting element is mounted rotatably about an axis of rotation with respect to a carrier element of the electrical module between an open position, in which insertion and removal of the contacting element into and from the mounting-rail profile are made possible, and a contacting position, in which the terminal contacts contact lines of the conductor rail,
wherein the contacting element has a cable-guiding channel which runs substantially along the axis of rotation and is in line with a feedthrough opening in the carrier element, and wherein at least one cable is guided from one of the terminal contacts, through the cable-guiding channel and the through-opening onto the side of the carrier element opposite from the contacting element in order to supply power to an electronic component of the module.

Furthermore, a contacting element is proposed for an electrical module for connecting to a mounting rail which has a mounting-rail profile having two side walls and at least one conductor rail, which is arranged on one of the two inner sides of the side walls of the mounting-rail profile and provides electrically contactable lines,
wherein the contacting element can be inserted into the mounting-rail profile and has terminal contacts, which are provided so that, in a state in which the contacting element has been inserted into the mounting-rail profile, they come into contact with lines of the conductor rail,
wherein the contacting element is mounted rotatably about an axis of rotation with respect to a carrier element of the electrical module between an open position, in which insertion and removal of the contacting element into and from the mounting-rail profile are made possible, and a contacting position, in which the terminal contacts contact lines of the conductor rail,
wherein the contacting element has a cable-guiding channel which runs substantially along the axis of rotation and at least one cable is guided from one of the terminal contacts and through the cable-guiding channel in order to supply power to an electronic component of the module.

Preferably, the contacting element has a base body that is rotatably accommodated in the carrier element of the electrical module and a contact holder body which holds the terminal contacts and is arranged on the base body and rotates together therewith, wherein both the base body and the contact holder body have openings which collectively form the central cable-guiding channel. This allows for the realization of a particularly advantageous development of the solution according to the invention, in which the contacting element is designed in such a way that it is prevented from being rotated too early when inserted into the mounting rail and individual contacts of the contacting element are prevented from unintentionally contacting the wrong lines of the conductor rails. In this particularly advantageous development, the contact holder body of the contacting element is mounted so as to be movable along the axis of rotation of the contacting element with respect to the base body, specifically between
a) a blocking position, in which a rotation of the contacting element is blocked, and
b) a release position, in which the contacting element can rotate,
wherein the contact holder body is preferably elastically prestressed into the blocking position and the contacting element particularly preferably has a spring, in particular a spiral spring, which acts between the base body and the contact holder body.

The contact holder body preferably comprises contact surfaces which are designed to interact with the mounting-rail profile in such a way that the contact holder body is moved in the direction of the release position when the contacting element is inserted into the mounting-rail profile, wherein the release position is preferably reached only when the electrical module is completely resting against the mounting rail. When the electrical module is connected to the mounting rail, the contact holder body is thus moved from the blocking position against the preferably present spring force in the direction of the release position by corresponding cooperation with the mounting-rail profile, wherein this is in particular only reached when the module is in the suitable position.

It can preferably be provided in this case that the contact holder body comprises blocking elements which, in the blocking position of the contact holder body, interact with the carrier element in such a way that rotation of the contacting element is blocked. In contrast, when the contact retaining body is in the release position, these blocking elements then engage in recesses or undercuts of the support element in such a way that a rotation of the contacting element is then enabled.

Preferably, it can further be provided that the contacting element has an additional mechanical locking part, which is arranged as a separate component on the base body and rotates together therewith. This locking part is then designed such that it brings about mechanical locking between the mounting-rail profile and the carrier element in the contacting position of the contacting element, wherein the additional locking part is preferably arranged as an insert part between the base body and the contact holder body. In comparison with the base part and the contact holder body, which are usually made of plastics, the additional locking part can be made of a different, in particular a more stable, material. For example, the additional locking part can be in the form of a sheet metal part or a metal part. This locking part significantly increases the force absorption such that even a single contacting element is sufficient to securely lock an electrical module with a relatively high weight to the mounting rail.

Locking by means of the additional locking part is preferably achieved in that said locking part has two outward-pointing arms which, in the contacting position of the contacting element, bring about the mechanical locking between the mounting rails and the carrier element. In particular, it can be provided that end regions of the two arms each engage behind both the mounting rail and the carrier element, wherein the end regions are particularly preferably C-shaped and engage behind the mounting rail from above on the one hand and the carrier element from below on the other. This enables particularly stable fastening of even very heavy electrical modules or luminaires to a mounting rail.

Overall, the design of the contacting element according to the invention means that said element now also makes it possible, as the only fastening component, to reliably hold electrical modules on a mounting rail. Due to the resulting advantageous positioning of the contacting element on the electrical module, the arrangement flexibility of such a module on a mounting rail is also increased.

### BRIEF DESCRIPTION OF THE DRAWINGS

The invention is explained in more detail in the following using the accompanying drawings. In the drawings:

FIG. 1 is an exploded view of an electrical module according to the invention having a corresponding contacting element;

FIG. 2 is a partial section through the contacting element;

FIG. 3 shows the arrangement of the contacting element within a schematically indicated mounting rail;

FIG. 4-7 show various possible ways of arranging electronic components on the bottom of the electrical module opposite the contacting element according to the invention, and

FIGS. 8 and 9 are views of an electrical module having a contacting element according to the prior art.

### DETAILED DESCRIPTION OF THE EXEMPLARY EMBODIMENT

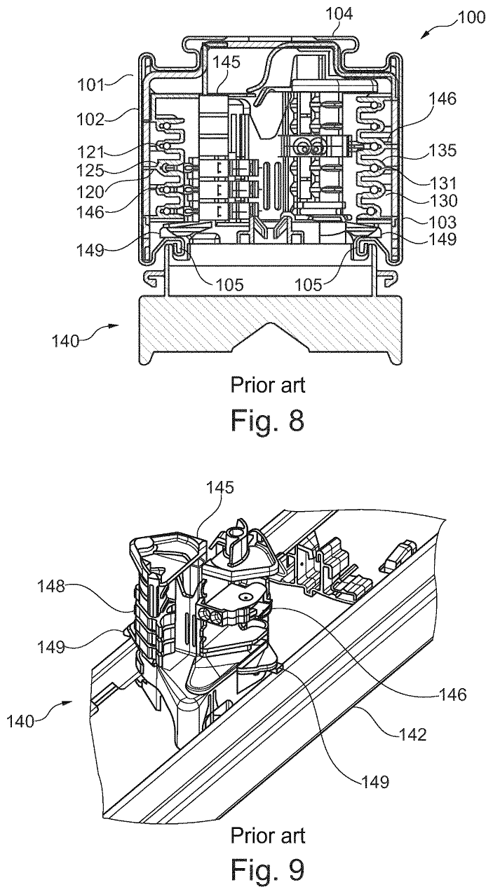

As already mentioned, the present invention represents, for example, a development of the known “TECTON” system. Before the solution according to the invention is described in more detail, the basic design of such a mounting rail system is therefore first to be explained below with reference to FIGS. 8 and 9.

FIG. 8 is a view of the mounting rail in which the conductor rails are arranged and are contacted by an electrical module—in this case by a luminaire. FIG. 9 in turn shows the design of a luminaire to be connected to this mounting rail system, comprising a contacting element provided for this purpose.

It is here initially apparent that, an elongated support profile rail 101 that is U-shaped in cross-section and downwardly open for the known mounting rail system 100 is used which delimits an elongated receiving space with its two side walls 102 and 103 and the upper connecting wall 104, said receiving space being accessible from the underside via an elongated coupling opening. In the case shown, a so-called busbar 120 or 130 is then arranged, respectively, on the inner sides of each of the two side walls 102 and 103, which busbar in each case has a plurality of wires or conductors 121, 131 running in the longitudinal direction, said wires or conductors being arranged in longitudinal channels or grooves of a conductor receiving structure 125, 135 consisting of an insulating material. The channels thereby ensure a safe mounting of the conductors 121, 131 such that they cannot be touched inadvertently. At the same time, however, the channels are in each case designed to be open towards the interior of the support profile rail 101, so that a contacting of the conductors 121, 131 is enabled.

A luminaire 140 to be connected to this mounting rail system 100 then has at least one rotatably mounted contacting or tapping element 145, as can be seen in particular in FIG. 9 and which is arranged on an elongated carrier element 142 of the luminaire 140. In order to connect the luminaire 140, the bottom thereof is attached to the elongated mounting profile rail 101, wherein the contacting element 145 is thereby inserted into the mounting profile rail 101 via the elongated coupling opening and then rotated by approximately 45°. Contacts 146 arranged on the contacting element 145 are thereby designed in such a way that they are pivoted out to the side by the rotational movement and thereby—as can be seen in particular in FIG. 8—then engage in the receiving channels of the two conductor rails 120, 130 in order to contact the corresponding conductors 121, 131.

In the case shown, contacts 146 are arranged on both sides of the contacting element 145 to enable contacting of the busbars 120, 130 positioned on the two side walls 102, 103 of the mounting profile rail 101. By virtue of the fact that the contacts 146, together with an associated contact holder part, can be moved vertically with respect to a contact holder body 148 of the tapping element 145, they can be arranged in accordance with the position of a desired conductor 121, 131 in order to then contact this corresponding conductor as desired. The possibility thereby exists, on the one hand, of a phase selection along with a selection of the neutral conductor for the power supply. Depending on the number of conductors made available by the busbars 120, 130, said conductors can then also be used for other purposes, such as for communication. The possibility thereby exists of combining the lighting units connected to the support profile rail 101 to form a larger light strip system, and of controlling the luminaires centrally from a central control unit.

Rotating the contacting element 145 to pivot the contacts 146 outward furthermore results in locking or latching projections 149 arranged on the contact holder body 148 also being pivoted out to the side. These latching projections 149 are also designed in such a way that they do not initially hinder insertion of the contacting element 145 into the mounting profile rail 101. However, if the contacting element 145 is then in the rotated contacting position, these latching projections 149 also protrude outward and in particular engage over inward-facing lower profile regions 105 of the mounting profile rail 101, thereby mechanically fastening the luminaire 140.

Moreover, in addition to the luminaire unit shown in FIGS. 8 and 9, other electrical units may also be connected to the mounting rail system. In particular, sensors such as e.g. presence or brightness sensors that support an automated operation of the illumination system would hereby be conceivable. Units that enable a communication or transmission of data for other purposes, independently of the lighting controller, would also be conceivable as useful units to be connected to the mounting rail system. Lastly, a wide variety of luminaire types are of course also conceivable—such as spots, suspended luminaires and the like—that may be collectively connected to the mounting profile rail and thereby fulfill different lighting technology tasks.

In addition to the contacting element 145 shown in FIG. 9, consumers to be connected to a mounting rail system usually also have a second identical contacting element, which, however, only serves for mechanical locking with the mounting rail. This second contacting element therefore has no terminal contacts that contact lines of the conductor rails after the contacting element has been rotated. Instead, the latching projections already mentioned are simply pivoted outward in order to in turn engage over corresponding profile regions of the mounting profile rail. In order to achieve even load distribution, the two contacting elements are arranged, if possible, on opposite sides of the electrical module to be connected.

If the electrical module to be connected is an elongated luminaire, the two contacting elements can, despite everything, still be arranged at a certain distance from the ends of the carrier element of the luminaire. In particular, this distance can be of such a size that it bypasses the feeding-in and feeding-out measures required at the beginning and end of a mounting rail system, and therefore it is possible to arrange luminaires in such a way that they extend as far as the furthest end of the mounting rail.

However, if the units to be connected are shorter, which may be the case with spots, sensors or similar components, for example, the contacting elements must be positioned more toward the edge region, meaning that the options for arranging such a consumer at the beginning or end of a mounting rail are limited. At the same time, the use of two rotary taps leads to increased material costs.

These problems can be avoided by means of the solution according to the invention described below, and therefore the possibilities for the variable design of a strip lighting system are increased even further.

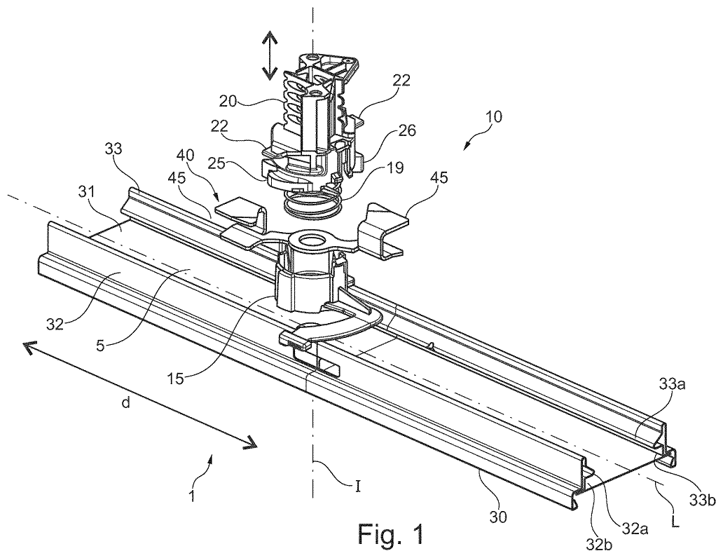

FIG. 1-3 show an electrical module 1 designed according to the invention for this purpose, which is characterized in particular by the specific design of the contacting element. The other components of the electrical module 1 are not shown here mainly for reasons of clarity.

The carrier element 30 of the electrical module 1 according to the invention is in turn designed in the form of a profile part which is attached to the mounting-rail profile and locked thereto. The carrier element 30 is generally a correspondingly shaped elongated sheet metal part which then supports the further components of the module 1. It is also known from the prior art to directly use a circuit board used for mounting LEDs as a carrier element and then to deform it accordingly. This would obviously also be conceivable within the scope of the present invention for forming shorter luminaires.

According to the representations, the carrier element 30 has a horizontal transverse connecting piece 31, which is delimited on both longitudinal sides by corresponding lateral regions 32 and 33. These form, together with the transverse connecting piece 31, a receiving region 5 which extends in the longitudinal direction L and serves in particular to accommodate at least the lower part of the contacting element 10. In particular, this contacting element 10 is accommodated in the receiving region 5 in such a way that it can be rotated relative to a vertically extending axis I, specifically between an open position on the one hand and a contacting position on the other hand.

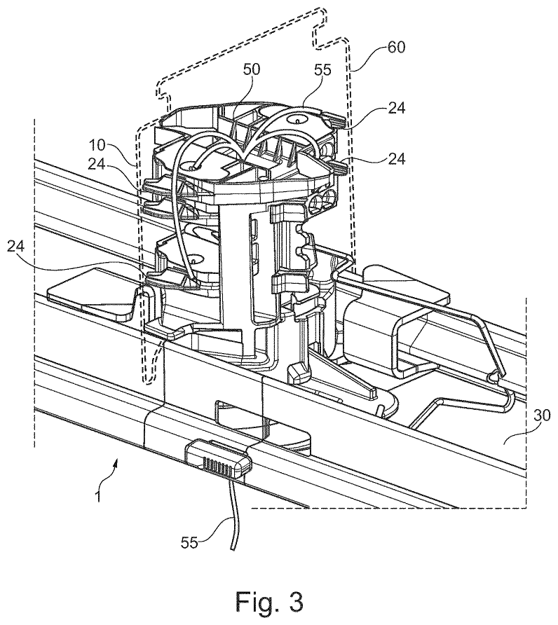

In the embodiment shown, the contacting element 10 can only be rotated if it is completely inserted into the mounting rail 60-as indicated schematically in FIG. 3. This is made possible by the fact that the contacting element 10 is formed from substantially two components; on the one hand, a base body 15 and, on the other hand, a contact holder body 20, wherein both components 15, 20 are coupled to one another in such a way that they can only be collectively rotated relative to the axis I. In relation to this axis I, they thus have a fixed relation to one another.

Furthermore, a relative movement can take place between the base body 15 and the contact holder body 20 along the axis of rotation I as shown by the double-headed arrow, wherein, by means of a spiral spring 19 supported on both elements, the contact holder body 20 is initially pressed into a position remote from the base body 15, which represents a so-called blocking position, when it is not loaded. In this blocking position, blocking elements 25 and 26 provided in the lower region of the contact holder body 20 are arranged at the level of inwardly projecting projections 32a, 33a of the side wall regions 32 and 33, respectively, of the carrier element 30 such that it is not possible to pivot the contacting element 10 out of the open position and into the contacting position.

Only by pressing the contact holder body 20 downward relative to the base body 15 counter to the spring force 19 are the two blocking elements 25 and 26 moved further downward such that they are now arranged at the level of undercuts 32b, 33b in the side wall regions 32, 33 of the carrier element 30. In this case, rotation of the contacting element 10 about the axis I is then made possible since the blocking elements 25 and 26 can now engage in these undercuts 32b, 33b.

The contact holder body 20 is automatically pressed downward into the release position when the electrical module 1 is attached to a mounting rail 60 such that the release position is reached the second the electrical module 1 has been fully attached to the mounting rail 60. For this purpose, the contact holder body 20 has corresponding contact surfaces which interact with the profile of the mounting rail 60 in such a way that when the electrical module 1 is attached to the mounting rail 60, the contact holder body 20 automatically moves against the spring force in the direction of the carrier element 30 until it is in the release position when the module 1 is fully attached to the mounting rail 60. Only then can the contact holder body 20 be rotated, which results in the previously blocked contacting elements pivoting out to the side in order to contact the lines of the conductor rails.

At the same time, first locking elements 22 are also provided on the contact holder body 20, which in turn engage over corresponding parts of the mounting-rail profile in such a way that, in addition to the electrical contact, the electrical module 1 is mechanically locked (for the first time) to the mounting rail 60.

In addition, mechanical fastening is further improved by using a further, separate locking part 40, which is arranged as an insert part between the base body 15 and the contact holder body 22. This locking part 40 is preferably a metal part, for example a sheet metal or a diecast aluminum part, although other materials would also be conceivable. In particular, however, the locking part 40 should be made of a more stable material than the contact holder body 20.

The locking part 40 is mounted in such a way that it rotates together with the base body 15 and the contact holder body 20. In the contacting position of the contacting element 10, the C-shaped end regions 45 of the locking part 40 engage over projections of the mounting-rail profile in a similar manner to the locking elements 22 of the contact holder body 20 and simultaneously engage under projections of the carrier element 30. The assembled combination consisting of the mounting-rail profile and the carrier element 30 is thus engaged over from both the top and the bottom, which ultimately results in extremely stable fastening of the electrical module 1 on the mounting rail 60, even in the case of heavier modules.

In principle, the use of a single contacting element 10 for reliably holding electrical modules 1 on mounting-rail profiles would be conceivable, but this would then pose the problem that the electrical components of the module would need to be suitably connected to the terminal contacts of the contacting element 10.

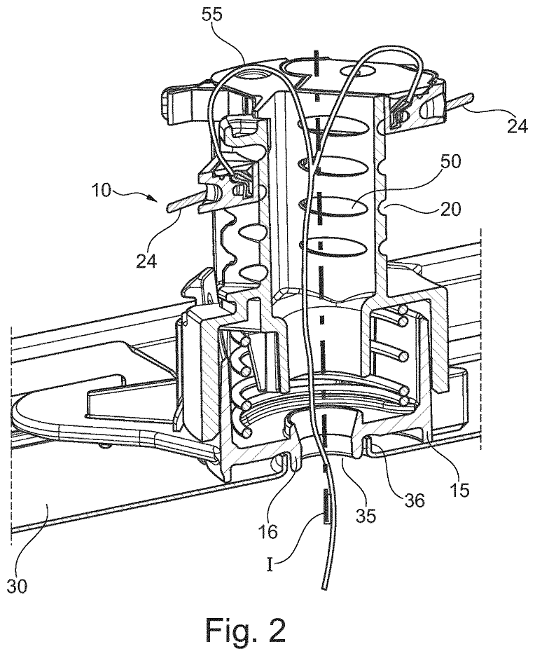

For this purpose, the invention provides that—as shown in FIG. 2—a channel 50 extending along the axis of rotation I is formed within the contacting element 20 and is in line with a circular opening 35 in the carrier element 30. The channel 50 is formed by corresponding openings in the contact holder body 20 and the base body 15. The circumferential ridge 36 provided at the opening 35 in the carrier element 30 also simultaneously serves to center the contacting element 10, as can be seen in FIG. 2, since a correspondingly circular flange region 16 of the base body 15 engages in the opening formed by the ridge 36.

What is crucial, however, is that the channel 50 and the opening 35 in the carrier element 30 in line therewith create a passage to the bottom of the carrier element 30 opposite in the contacting element 10, through which a power supply or other electrical connection of a consumer located at this position can be made.

As can be seen in FIG. 3, it is therefore provided that, starting from the terminal contacts 24, corresponding cables or lines 55 are inserted into the channel 50 from the top and then extend through the channel 50 and the through-opening 35 in the carrier element 30 to the bottom so that a consumer can be directly arranged and supplied with power here.

This configuration makes it possible to position both the contacting element 10 and the consumer to be supplied with power in the center of the carrier element 30 with respect to the longitudinal direction. This was previously not possible, since the cable connecting the terminal contacts 24 to the consumer was routed through the carrier element 30 via an opening that is laterally offset in the longitudinal direction with respect to the contacting element 10. This solution required that at least one of the two components-the contacting element 10 or the unit to be supplied with power-was positioned off-center. Ultimately, this led to the fact that in previous solutions the unit to be supplied with power was arranged in the center of the bottom of the carrier element 30, but then corresponding contacting elements 10 were positioned off-center and thus on both sides.

However, as already mentioned, the present invention now creates the possibility of positioning both components in the center of the carrier element 30 and, despite everything, creating a suitable electrical connection. This applies to a wide variety of consumers to be arranged on the bottom of the carrier element 30, with FIG. 4-7 showing various examples of this.

FIG. 4, for example, shows as a first exemplary embodiment an electrical module 1 which contains a sensor 70 on the bottom of the carrier element 30. This sensor 70 can, for example, be a brightness and/or presence sensor. Said sensor is accommodated in a cylinder-like housing 72, which, however, is significantly shorter than the longitudinal extent of the carrier element 30. Arranging the sensor 70 in the center when viewed in the longitudinal direction is advantageous for aesthetic reasons in this case, wherein now, due to the possibility of also arranging the contacting element (not shown) in the center, the use of a single contacting element for electrically coupling to the conductor rail(s) and for mechanically fastening to the mounting rail is sufficient.

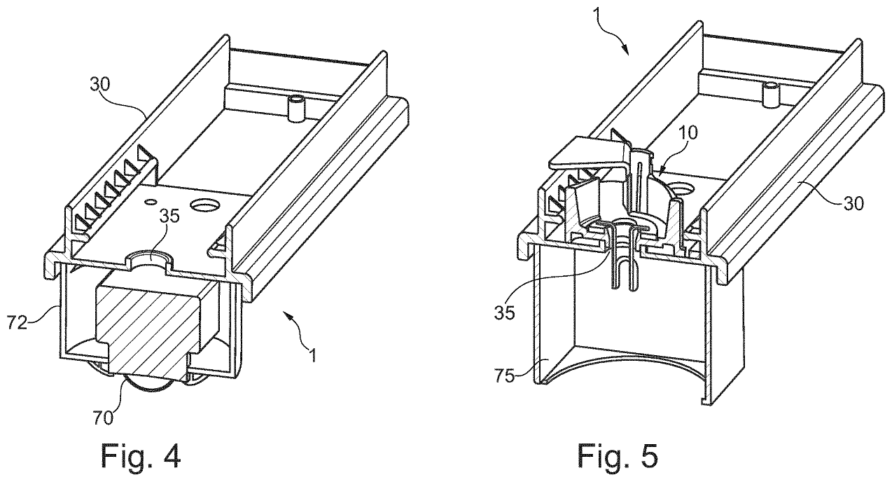

FIG. 5 shows the possibility of arranging a box 75 in the center below the—partially indicated—contacting element 10, in which the electrical coupling of a consumer then takes place. This variant is suitable, for example, for luminaires that are then suspended from the box 75 via a cable. Again, the length of the carrier element 30 can be relatively short, although the central arrangement of both the box 75 and the contacting element 10 allows for balanced force transmission.

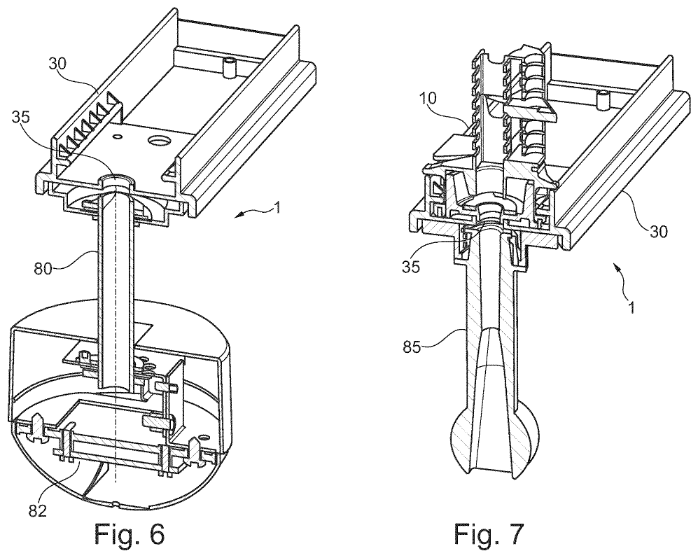

Similarly, a radiating element or a sensor can also be connected by means of a tube 80 extending downward from the bottom of the carrier element 30, as shown in FIG. 6. The actual consumer 82 is then positioned on the bottom of the tube 80 and thus at a distance from the carrier element 30.

Lastly, FIG. 7 shows the basic possibility of positioning a universal adapter 85 below the through-opening 35 in the carrier element 30, which adapter then serves to hold, for example, different radiating elements or the like.

In all the variants shown, a single contacting element 10 may thus now be used for fastening the electrical module to the mounting rail as well as for providing electrical contact and supplying power. A consequence of this is that—as indicated in FIG. 1—the carrier element 30 protrudes by a certain distance d on both sides of the contacting element 10 in the longitudinal direction L. This is now ideally of such a size that it bypasses corresponding coupling and decoupling measures at the end region of the mounting rail such that even modules that are relatively short can now be positioned as far as the furthest end of a mounting rail.

Finally, it should be pointed out that the measures described above with regard to securing against premature, unintentional rotation of the contacting element and the use of the additional locking element represent particularly advantageous developments of the invention. In principle, however, it would also be conceivable to dispense with these measures and thus make the structure of the contacting element simpler, provided that it still has the channel according to the invention, which allows for the particularly advantageous cable guiding and thus connection of the electrical consumer.

1. An electrical module (1) for connecting to a mounting rail which has a mounting-rail profile (60) with two side walls and which also has at least one conductor rail, which is arranged on one of the two inner sides of the side walls of the mounting-rail profile and provides electrically contactable lines,
wherein the electrical module (1) has a contacting element (10), which can be inserted into the mounting-rail profile (60) and has terminal contacts (24), which are provided so that, in a state in which the contacting element (10) has been inserted into the mounting-rail profile (60), they come into contact with lines of the conductor rail,
wherein the contacting element (10) is mounted rotatably about an axis of rotation (I) with respect to a carrier element (30) of the electrical module (1) between an open position, in which insertion and removal of the contacting element (10) into and from the mounting-rail profile (60) are made possible, and a contacting position, in which the terminal contacts (24) contact lines of the conductor rail,
wherein
the contacting element (10) has a cable-guiding channel (50) which runs substantially along the axis of rotation (I) and is in line with a feedthrough opening (35) in the carrier element (30), and
at least one cable (55) is guided from one of the terminal contacts (24) through the cable-guiding channel (50) and the through-opening (35) onto the side of the carrier element (30) opposite from the contacting element (10), in order to supply power to an electronic component of the module (1).

2. The electrical module according to claim 1,
wherein
the contacting element (10) comprises a base body (15), which is rotatably accommodated in the carrier element (30) of the electrical module (1), and a contact holder body (20), which holds the terminal contacts (24) and is arranged on the base body (15) and rotates together therewith,
wherein both the base body (15) and the contact holder body (20) have openings which collectively form the cable-guiding channel (50).

3. The electrical module according to claim 2,
wherein
the contact holder body (20) is mounted so as to be adjustable relative to the base body (15) along the axis of rotation (I) between
a) a blocking position, in which a rotation of the contacting element (10) is blocked, and
b) a release position, in which the contacting element (10) can rotate,
wherein the contact holder body (20) is preferably elastically prestressed into the blocking position and the contacting element particularly preferably has a spring (19), in particular a spiral spring, which acts between the base body (15) and the contact holder body (20).

4. The electrical module according to claim 3,
wherein
the contact holder body has contact surfaces (27, 28) which are designed to interact with the mounting-rail profile (60) in such a way that the contact holder body (20) is moved in the direction of the release position when the contacting element (10) is inserted into the mounting-rail profile (60),
wherein the release position is preferably reached only when the electrical module (50) is completely resting against the mounting rail (60).

5. The electrical module according to claim 3,
wherein
the contact holder body (20) has blocking elements (25, 26) which, in the blocking position of the contact holder body (20), interact with the carrier element (30) in such a way that rotation of the contacting element (10) is blocked,
wherein the blocking elements (25, 26) engage, in the release position of the contact holder body (10), in recesses or undercuts (32b, 33b) in the carrier element (30) in such a way that the contacting element (10) can rotate.

6. The electrical module according to claim 2,
wherein
the contacting element (10) has an additional mechanical locking part (40) which is arranged as a separate component on the base body (15) and rotates therewith,
wherein the locking part (40) brings about mechanical locking between the mounting-rail profile (60) and the carrier element (30) in the contacting position of the contacting element (10),
wherein the additional locking part (40) is preferably arranged as an insert part between the base body (15) and the contact holder body (20).

7. The electrical module according to claim 6,
wherein
the additional locking part (40) consists of a different material than the base body (15) and/or the contact holder body (20), in particular of a more stable material,
wherein the additional locking part (40) is preferably in the form of a sheet metal part or metal part.

8. The electrical module according to claim 6,
wherein
the additional locking part (40) has two outward-pointing arms which, in the contacting position of the contacting element (10), bring about the mechanical locking between the mounting-rail profile (60) and the carrier element (30),
wherein end regions (45) of the two arms preferably each engage behind both the mounting-rail profile (60) and the carrier element (30), and
wherein the end regions (45) are particularly preferably C-shaped and engage behind the mounting-rail profile (60) from above and the carrier element (30) from below.

9. The electrical module according to claim 1,
wherein
said module has a single contacting element (10),
wherein the contacting element is preferably arranged in the center of the carrier element (30).

10. The electrical module according to claim 9,
wherein
the electronic component of the module (1) is arranged opposite the contacting element (10) on the carrier element (30).

11. The electrical module according to claim 1,
wherein
the electronic component is a radiating element, a sensor or a camera.

12. A contacting element (10) for an electrical module (1) for connecting to a mounting rail, which has a mounting-rail profile (60) with two side walls and at least one conductor rail, which is arranged on one of the two inner sides of the side walls of the mounting-rail profile (60) and provides electrically contactable lines,
wherein the contacting element (10) can be inserted into the mounting-rail profile (60) and has terminal contacts (24), which are provided so that, in a state in which the contacting element (10) has been inserted into the mounting-rail profile (60), they come into contact with lines of the conductor rail,
wherein the contacting element (10) is mounted rotatably about an axis of rotation (I) with respect to a carrier element (30) of the electrical module (1) between an open position, in which insertion and removal of the contacting element (10) into and from the mounting-rail profile (60) are made possible, and a contacting position, in which the terminal contacts (24) contact lines of the conductor rail,
wherein
the contacting element (10) has a cable-guiding channel (50), which runs substantially along the axis of rotation (I), and
at least one cable (55) is guided from one of the terminal contacts (24) through the cable-guiding channel (50) in order to supply an electronic component of the module (1)

13. he contacting element according to claim 12,
wherein
the contacting element (10) comprises a base body (15), which is rotatably accommodated in the carrier element (30) of the electrical module (1), and a contact holder body (20), which holds the terminal contacts (24) and is arranged on the base body (15) to rotate together therewith,
both the base body (15) and the contact holder body (20) having openings which collectively form the cable-guiding channel (50).

14. The contacting element according to claim 13,
wherein
the contact holder body (20) is mounted so as to be adjustable relative to the base body (15) along the axis of rotation (I) between
a) a blocking position, in which a rotation of the contacting element (10) is blocked, and
b) a release position, in which the contacting element (10) can rotate,
the contact holder body (20) preferably being elastically prestressed into the blocking position and the contacting element particularly preferably having a spring (19), in particular a spiral spring, which acts between the base body (15) and the contact holder body (20).

15. The contacting element according to claim 12,
wherein
the contacting element (10) has an additional mechanical locking part (40) which is arranged as a separate component on the base body (15) and rotates therewith,
the locking part (40) bringing about mechanical locking between the mounting-rail profile (60) and the carrier element (30) in the contacting position of the contacting element (10),
the additional locking part (40) preferably being arranged as an insert part between the base body (15) and the contact holder body (20).
